(19) United States
(12) Patent Application Publication
(10) Pub. No.: US 2011/0028869 A1
(43) Pub. Date: Feb. 3, 2011

(54) EXERCISE EQUIPMENT

(76) Inventors: Bungo Imai, Hirakata-shi (JP); Fumihiro Nishio, Hikone-shi (JP); Takahisa Ozawa, Katano-shi (JP); Wataru Sanematsu, Hirakata-shi (JP); Naoto Shirasawa, Kyoto-shi (JP)

Correspondence Address: Cheng Law Group, PLLC, 1100 17th Street, N.W., Suite 503, Washington, DC, 20036, US

(21) Appl. No.: 12/935,328

(22) PCT Filed: Mar. 31, 2008
(86) PCT No.: PCT/JP2008/056433

§ 371 Date: Sep. 29, 2010

(51) Int. Cl. A61H 1/00

(52) U.S. Cl. 601/5

(57) ABSTRACT

An exercise equipment comprises a movable portion 7 for supporting a user, a driving means for driving the movable portion 7. Further the exercise equipment comprises a stimulus means 87, detectors 86, 88, and a judgment means C2. The stimulus means 87 is configured to apply an informational stimulus to the user supported by the movable portion 7. The detectors 86, 88 detect a motion of the user supported by the movable portion. The judgment means C2 is configured to perform a judgment based on outputs from the stimulus means and the detector. Therefore, the exercise equipment can provide the user with both of effective passive and active exercises.

### TECHNICAL FIELD

The present invention relates generally to exercise equipments, and more particularly to an exercise equipment that provides a user with a passive exercise.

### BACKGROUND ART

In the past, there have been proposed various types of exercise equipments which apply external forces generated by a driving means to a user's body and make the user's body generate resistance to said external forces in order to give an exercise effect to the user's body. For example, one of these equipments is known to be an exercise equipment resembling a horse riding, as shown in Japanese Patent Application Laid-Open No. 2001-286578.

### DISCLOSURE OF THE INVENTION

### Problems to be Solved by the Invention

An exercise by the above-mentioned equipment makes the user' body generate both a motion according to an action of a movable portion for applying external forces to the body, and a motion to resist the action of the movable portion, at the same time. It is important that when and how are such motions generated with respect to the action of the movable portion, in order to increase exercise efficiency.

However, when the user uses the above-mentioned passive exercise equipment for the first time, the user often moves so as to resist the action of the movable portion immoderately, or a large difference often occurs between a timing of the action of the movable portion and a timing of the user's motion according to the action. In this case, it is difficult for the user to perform an effective exercise.

In addition, there is also a request of wanting to perform an active exercise without being satisfied with a passive exercise. However, the above-mentioned passive exercise equipment can not respond appropriately to this request, and thus the user has no choice but to exercise one's body accordingly on the passive exercise equipment.

It is an object of the present invention to provide an exercise equipment which can provide a user with both of effective passive and active exercises.

### Means for Solving the Problem

In order to solve the above problem, an exercise equipment of the present invention comprises a movable portion for supporting a user, a driving means for driving the movable portion, a stimulus means, a detector, and a judgment means. The stimulus means is configured to apply an informational stimulus to the user supported by the movable portion. The detector detects a motion of the user supported by the movable portion. The judgment means is configured to perform a judgment based on outputs from the stimulus means and the detector.

The informational stimulus may be a light, an image, a sound, or an oscillation etc. In addition, the informational stimulus is not limited to them if being a stimulus which the user can recognize. For example, an action itself of the movable portion may be used as the informational stimulus. The detector may be a switch operated by the user, a force sensor, a contact sensor, or a noncontact sensor etc. They may be selected to be used accordingly. In addition, for example, an acceleration sensor attached to the user may be used to detect the motion of the user. Furthermore the detector may manipulate an image which is obtained by imaging the user supported by the movable portion, in order to detect the motion of the user.

It's preferred that the stimulus means is configured to apply the informational stimulus according to the action of the movable portion to the user because the active exercise can be combined with the passive exercise effectively. However, the stimulus means may be configured to apply the informational stimulus which does not accord to the action of the movable portion.

The stimulus means may be configured to apply the informational stimulus based on a result judged by the judgment means, and thereby the exercise equipment can change a timing and a interval relevant to an output of the informational stimulus according to the user's response to the informational stimulus, and can make the user perform more highly exercise easily.

In addition, the driving means may drive the movable portion based on a result judged by the judgment means, and thereby the exercise equipment can change an action speed of the movable portion according to the user's response to the informational stimulus, and can make the user perform more highly exercise easily.

Furthermore, the detector may be configured to change a detection level based on a result judged by the judgment means, and thereby the exercise equipment can make the user perform more accurate exercise or more heavy exercise easily, according to the user's response to the informational stimulus.

The exercise equipment may comprise a resistance means for giving a resistance to a motion of the user's body, and the resistance means may be configured to change the resistance based on a result judged by the judgment means. In this case, the exercise equipment can also make the user perform more heavy exercise according to the user's response to the informational stimulus.

The exercise equipment may comprise an output portion for outputting a result judged by the judgment means as a control signal for an external device, and thereby the external device also can be used as a part of the exercise equipment.

### Advantageous Effect of the Invention

The exercise equipment of the present invention applies the informational stimulus to the user supported by the movable portion via the stimulus means, and detects the motion of the user supported by the movable portion via the detector, and comprises the judgment means which is configured to perform a judgment based on outputs from the stimulus means and the detector. Thus, the stimulus means applies the informational stimulus according to the action of the movable portion for the passive exercise, and thereby the exercise equipment can inform a timing of the passive exercise and a motion to be taken to the user, and then the exercise equipment can determine whether the user's motion is appropriate. In addition, the exercise equipment can make the user perform the active exercise by setting what kind of the user's motion is detected and is outputted. Therefore, the user can perform a very effective exercise by using the exercise equipment.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is an oblique perspective figure according to an embodiment of the present invention;

FIG. 2 is a block diagram according to said embodiment; and

FIG. 3 is an oblique perspective figure according to another embodiment.

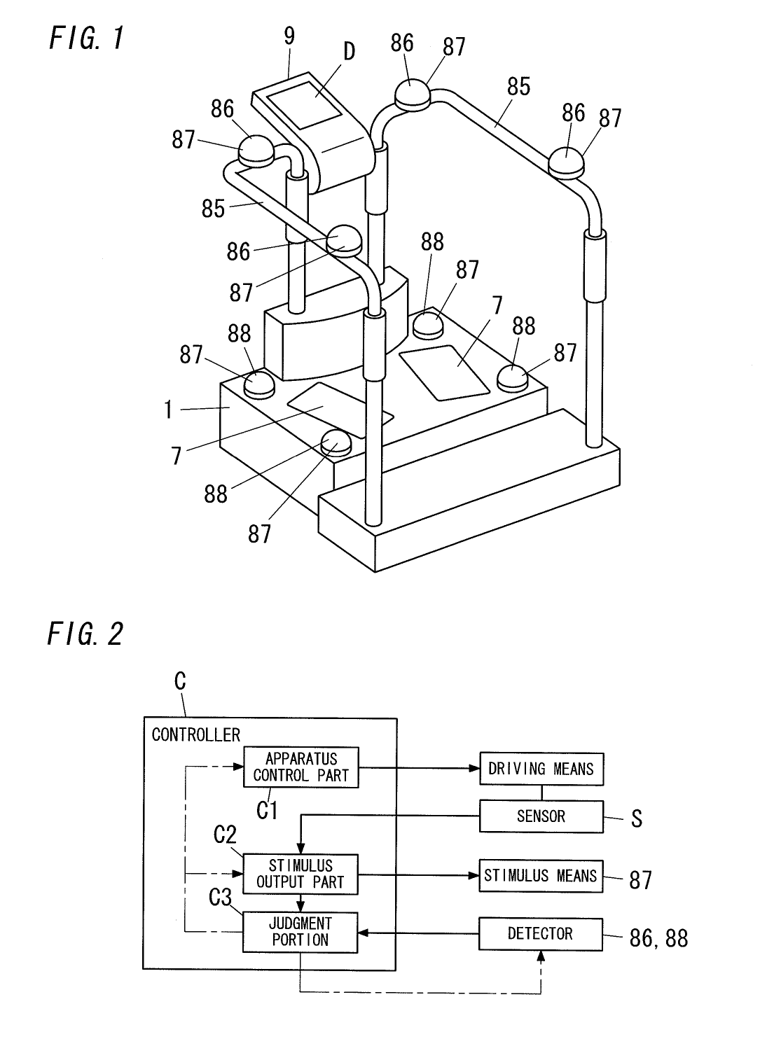

### EXPLANATION OF REFERENCES

1 PLATFORM

C CONTROLLER

C3 JUDGMENT PORTION

86 SWITCH

87 LIGHT EMITTING PART

### BEST MODE FOR CARRYING OUT THE INVENTION

Hereinafter, An embodiment of the present invention is explained based on attached drawings. An exercise equipment shown in the figure comprises a platform 1 which is provided on its top surface with left and right steps 7, 7, left and right handrails 85, 85 which are extend so as to stand from the platform 1 and of which heights can be adjusted in a vertical direction, respectively, an operation panel 9 which is located so as to use a part of the handrails 85, 85 in a front side of the platform 1, and a step driving means (not shown) which is located inside the platform 1 and drives the steps 7, 7. A user rests one's left and right feet on the steps 7, 7 while standing and gripping the left and right handrails 85, 85 with one's hands, respectively. In this standing position, the step driving means drives to move the steps 7, 7, and thereby the exercise equipment provides the user's leg with a passive exercise.

For example, it is preferred that the following step driving means is used in the present embodiment. That is, the step driving means drives each of the steps 7, 7 so as to change a vertical position relation between front and rear ends of each of the steps 7, 7 while sliding and reciprocating each of the steps 7, 7 in front-back and left-and-right directions, and thereby the user's feet rested on the steps 7,7 repeat a plantar flexion motion such as moving the user's toe side downward and a dorsi flexion motion such as moving said toe side upward, respectively. Detailed explanation of the step driving means is omitted here.

Push-button switches 86, 86 are located at front and rear sides of each of the left and right handrails 85, 85, respectively, and a light emitting part 87 is mounted inside each of the switches 86, 86. That is, four switches 86 are located in a total of four positions of the left and right handrails 85, 85, respectively. Each of the push-button switches 86, 86 constitutes a detector in the present embodiment, and the light emitting part 87 constitutes a stimulus means for applying a light stimulus to the user.

In this exercise equipment, the switch 86 having the light emitting part 87 performs the following plurality of roles. In one of the plurality of roles, the front-right side's switch 86 lights one's light emitting part 87, when the steps 7, 7 are driven and the right step 7 is moved forward and the user's right toe side is moved downward. The front-left side's switch 86 lights one's light emitting part 87, when the left step 7 is moved forward and the user's left toe side is moved downward.

When the left and right steps 7, 7 are alternately moved in a front-back direction and either of steps 7, 7 is moved forward and the user's toe side is moved downward, it is preferred that the user keeps user's weight on the foot rested on said either of steps 7, 7 in order to increase exercise efficiency. In the present embodiment, the switch 86 lights the light emitting part 87 according to such action timing of the steps 7, 7, and thereby the user can determine the user's foot on which the user should keep the user's weight.

The user's foot is moved by such action of the step 7 and thereby the exercise equipment provides the user with the passive exercise. In this time, if the user operates the switch 86 according to a light timing of the light emitting part 87 mounted in the switch 86, the exercise equipment can provide the user with an active exercise.

The light emitting part 87 of the switch 86 is lighted according to the action of the step 7. Therefore, the exercise equipment can determine whether the user is just exercising according to the action of the step 7, if the user operates the lighted switch 86.

A controller C is shown in FIG. 2, and is provided with a judgment portion C3 configured to perform such a judgment. In the figure, C1 is an apparatus control part for controlling to drive the above-mentioned step driving means, and C2 is a stimulus output part which makes the stimulus means (the light emitting part 87) output the informational stimulus.

A sensor S detects an operation of the step driving means controlled to drive by the apparatus control part C1, or the action of the step 7. The stimulus output part C2 detects an emission timing of the light emitting part 87 based on an output of the sensor S, and lights the light emitting part 87 for a predetermined period.

If the light emitting part 87 is lighted for the predetermined period and the user operates the switch 86 provided with the light emitting part 87 within the predetermined period, the judgment portion C3 determines that the user's motion is appropriate. Thus, for example, the judgment portion C3 directs the apparatus control part C1 to increase a little action speed.

If an operation timing of the user is early or late with respect to the predetermined period, the judgment portion C3 determines that the user's motion is inappropriate, and directs the apparatus control part C1 to increase a little action speed. Or the judgment portion C3 may control to stop the action of the step 7 driven by the step driving means. Therefore, the user has to operate the switch 86 at the right timing in order to complete the exercise.

As mentioned, the judgment portion C3 performs a judgment based on the motion of the user response to the informational stimulus, and then a result judged by the judgment portion C3 may be accumulated, and the exercise equipment may provide the user with a score calculated based on the accumulated result as an evaluation of the exercise when the exercise is finished.

In any case, when the user's foot is moved according to the action of the step 7 and thereby the passive exercise is applied to the user's leg, the user operates the switch 86 at the right timing and thereby the active exercise is applied to the user's upper body. Therefore, the user can perform more exercises.

The exercise equipment can be configured so as to shorten an emitting period of the light emitting part 87 and to raise a standard for determining whether the switch 86 is operated at the right timing, with respect to the user who can operates the switches 86, 86 located in front and left-and-right appropriately.

If the exercise equipment is configured so that the user also has to operate the switches 86, 86 provided with the light emitting parts 87,87 located in back and left-and-right, the user can perform more highly exercises. A light timing of the back side's light emitting parts 87, 87 is earlier than that of the front side's light emitting parts 87, 87. That is, the user operates the back-right side's switch 86 just when the right step 7 is being moved forward, and operates the front-right side's switch 86 when the right step 7 reaches to a front end and the above-mentioned plantar flexion is being performed.

In addition, the operation timing of these switches 86 is not limited to the above example. If the user can perform the above-mentioned exercise smoothly, the exercise equipment may be configured so that the user operates the front-left side's switch 86 with the user's right hand when the right step 7 is moved forward. That is, such a configuration can make the user exercise to twist one's body.

Footswitches 88 (or a load sensor) may be located around the steps 7, 7 on the top surface of the platform 1, and each of the footswitches 88 is provided with the light emitting part 87. Then, the exercise equipment may be configured so that the user operates the front-left footswitch 88 with the user's left foot when the right step 7 is moved forward and the user's right foot is plantarflexed. In this case, a light timing and a lighting place of the light emitting parts 87 are not limited.

In particular, the light emitting part 87 is lighted at a timing according to the action of the step 7 in the above-mentioned example. However, the light emitting part 87 may be lighted at a timing, for example a random timing, which does not accord to the action of the step 7 if the user hopes to perform more active exercises. Then, the exercise equipment may be configured so as to determine whether the user appropriately operates the lighted switches 86, 88 within a lighting period.

In this case, the user has to operates any one of the switches 86, 88, while keeping a body balance according to the action of the steps 7, 7. Therefore, the user can perform much active exercise.

The informational stimulus provided the user is the light stimulus by the lighted light emitting part 87 in the above example. However, other than the light stimulus, the informational stimulus may be an image, a sound, or an oscillation etc. and also the detector for detecting the motion of the user may be not only the switch or the footswitch but also a contact-type switch, a noncontact-type switch (a noncontact sensor), or a force sensor etc.

In addition, when an oscillation stimulus is used, for example an oscillation generating means is located inside the handrail 85, and the force sensor is located in a part of the handrail 85 which the user grips with the hand. In this configuration, if the user grips the handrail 85 generating an oscillation with strength, the force sensor detects this.

In the above example, it is explained that the exercise equipment is configured to reflect the result judged by the judgment portion C3 in the output of the informational stimulus, and in the action of the step 7 which is the movable portion. However, other than these, the exercise equipment may be configured to reflect the result in a motion of the detector for detecting the motion of the user.

For example, when the force sensor is used as the detector and detects the motion of the user, the exercise equipment is configured to raise the force sensor's standard value (a threshold value) for determining whether the user's motion is detected if the judgment portion C3 determines that the user's motion is appropriate. That is, it becomes necessary for the user to apply more force to the force sensor in order to be detected by the force sensor, and thereby the user can perform more exercises.

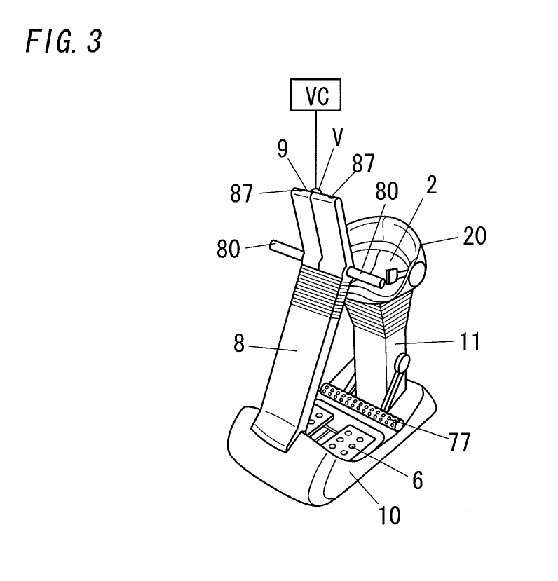

An another embodiment is shown in FIG. 3. An exercise equipment shown in the figure comprises a main unit 10, a rising unit 11 which is located so as to rise from a rear side of the main unit 10, and a seat unit 2 in which the user sits and which is located in a top end of the rising unit 11. A seat driving means (not shown) is configured to oscillate the seat unit 2 in front-back and left-right directions, and is located inside the rising unit 11. A supporting unit 8 is located so as to extend upward from a front end of the main unit 10. A top end of the supporting unit 8 is provided with an operation panel 9 and left and right handles 80, 80.

In addition, left and right footrests 6, 6 are located in a front side of a top surface of the main unit 10, and the user can rest the user's feet on the left and right footrests 6, 6, respectively, while sitting in the seat unit 2. The rising unit 11 is provided with a kicking strap 77. The kicking strap 77 is located at a position as shown in FIG. 3 when not used. Then, the kicking strap 77 is displaced upward from the position when used.

In the present embodiment, the movable portion is the seat unit 2. The seat unit 2 is provided with a backrest 20, and drives to oscillate in a front-back direction and a left-right direction by the seat driving means. The seat unit 2 drives two cycle oscillations in the front-back direction while driving one cycle oscillation in the left-right direction, and thus the seat unit 2 oscillates forward when inclining toward the right, and also oscillates forward when inclining toward the left, and such a action is alternately performed.

This exercise equipment can perform the following two exercises individually. In one of the two exercises, when the user sits in the seat unit 2 and rests the user's feet on the left and right footrests 6, 6, respectively, and grips the handles 80, 80, the above-mentioned oscillation is performed. The user has to move to press down either of the left and right footrests 6, 6 when bending the user's body in an oscillation direction according to the front-back and left-right oscillation of the seat unit 2. In this time, it is preferred that each of the footrests 6, 6 is configured so as to sink against a load of a spring when a force is applied.

In the other of the two exercise, when the kicking strap 77 is displaced upward and the user sits in the seat unit 2 and rests the user's feet on the kicking strap 77, the oscillation of the seat unit 2 is performed. This is an exercise resembling a horse riding like the prior example, and the user performs an exercise to keep balance according to the oscillation of the seat unit 2.

In such exercise equipment, the detector may be the same as that of the above-mentioned embodiment, and that is, a switch of push-button type may be used. However, in the present embodiment, an image processing circuit VC is used as the detector, and manipulates an image of the user's upper body imaged by a television camera V, which is located in an upper end of the operation panel 9, in order to extract the user's motion. Light emitting parts 87, 87 are used as the stimulus means, and are located in left and right ends of the upper end of the operation panel 9, respectively.

The light emitting parts 87, 87 are lighted according to the oscillation of the seat unit 2, especially the oscillation in a left-right direction. If the user bends the user's upper body in an oscillation direction according to either of the lighted left and right light emitting parts 87, 87, the image processing circuit VC captures this motion via the television camera V, and sends a signal relevant to a bending direction to the judgment portion C3. Then, the judgment portion C3 determines whether the user's motion is appropriate. Here, the user's motion is performed according to the action of the seat unit 2 and a light of the light emitting part 87.

If the judgment portion C3 determines that the user's motion is appropriate, the controller C may control so that an oscillation speed of the seat unit 2 increases, like the above-mentioned embodiment. However, in the present embodiment, the exercise equipment may be configured to increase a load of a spring biasing the footrest 6. That is, when the user presses down the footrest 6 with the user's foot, the exercise equipment may be configured to increase a resistance to the user's pressing motion.

Also, for example, the handles 80, 80 is formed into a shape of a pedal crank to be rotatable. Then, the exercise equipment may be is configured to determine whether the user rotates the appropriate handle 80 directed by the stimulus means. In this case, the user can add an exercise such as moving the user's arm, and furthermore can increase cooperativeness relevant to motions of the user's feet and hands.

In addition, the footrest 6 or the step 7 may be provided a member which the user can grip with the user's toe. When the informational stimulus is applied and the user grips the member with the toe, this griping motion is detected. Therefore, the user can develop the toe's muscles.

The detector may comprise a plurality of detectors. For example, the plurality of detectors are used in order to detect motions of the user's upper body, arms, and feet, respectively. Outputs of these detectors are all sent to the judgment portion C3. In the exercise resembling a horse riding, the user has to bend the user's body in the opposite direction of an incline direction of the seat unit 2 in order to keep balance. Thus, the exercise equipment is configured to light the light emitting part 87 which is located in the opposite direction of an incline direction of the seat unit 2, and the judgment portion C3 also performs a judgment by using this standard.

If the user hopes more active exercises, the exercise equipment may be configured to light either of the left and right light emitting parts 87, 87 at a timing which does not accord to the oscillation of the seat unit 2. The user has to bend the user's body toward a direction directed by the light emitting part 87 while keeping balance, and thereby a difficulty level of the exercise increases.

A display D is mounted in the operation panel 9, and an image shown in the display D is used as the stimulus means. A boxing image that one throws left and right punches or an incoming obstacle's image may be used as this image shown in the display D. The judgment portion C3 determines whether the user appropriately performs a motion to avoid the punches or the obstacle, and thereby the exercise equipment can introduce a game element.

The user's motion may be detected not by manipulating an image but by using an acceleration sensor which the user has with hand etc. (or which is attached to the user). The exercise equipment may comprise the steps 7, 7 which are provided with a plurality of load sensors, respectively, and the load sensors may calculate a position of the user's weighted center to judge the user's motion.

A result judged by the judgment portion C3 may be outputted as a control signal for an external device of a game machine, a television, an air conditioner, or an illumination etc. and the external device may be controlled to change an operation according to the judged result. By the way, the action of the movable portion is a periodic motion, as the above-mentioned step 7 and seat unit 2, when the exercise equipment applies the informational stimulus according to the action of the movable portion to the user. Therefore, if the exercise equipment applies a rhythmic sound or image to the user, the user's motion can be improved. For this reason, it is preferred that the exercise equipment is configured to output the rhythmic sound or image according to an output timing of the informational stimulus. Also, the exercise equipment may be configured to drive the movable portion 2 according a rhythm.

1. An exercise equipment comprising:
a movable portion for supporting a user;
a driving means for driving the movable portion;
a stimulus means being configured to apply an informational stimulus to the user supported by the movable portion;
a detector for detecting a motion of the user supported by the movable portion; and
a judgment means being configured to perform a judgment based on outputs from the stimulus means and the detector.

2. The exercise equipment as claimed in claim 1, wherein the stimulus means is configured to apply the informational stimulus according to an action of the movable portion to the user.

3. The exercise equipment as claimed in claim 1 or 2, wherein the stimulus means is configured to apply the informational stimulus based on a result judged by the judgment means.

4. The exercise equipment as claimed in any one of claims 1-3, wherein the driving means drives the movable portion based on a result judged by the judgment means.

5. The exercise equipment as claimed in any one of claims 1-4, wherein the detector is configured to change a detection level based on a result judged by the judgment means.

6. The exercise equipment as claimed in any one of claims 1-5, further comprising a resistance means for giving a resistance to a motion of the user's body, wherein the resistance means is configured to change the resistance based on a result judged by the judgment means.

7. The exercise equipment as claimed in any one of claims 1-6, further comprising an output portion for outputting a result judged by the judgment means as a control signal for an external device.
